(19) United States
(12) Patent Application Publication
(10) Pub. No.: US 2014/0306575 A1
(43) Pub. Date: Oct. 16, 2014

(54) ENHANCED THERMIONIC ENERGY CONVERTER AND APPLICATIONS OF SAME

(71) Applicant: VANDERBILT UNIVERSITY, Nashville, TN (US)

(72) Inventors: William F. Paxton, Nashville, TN (US); Jim L. Davidson, Brentwood, TN (US); Weng P. Kang, Brentwood, TN (US); Mick E. Howell, Murfreesboro, TN (US)

(73) Assignee: VANDERBILT UNIVERSITY, Nashville, TN (US)

(21) Appl. No.: 14/250,893

(22) Filed: Apr. 11, 2014

Related U.S. Application Data
(60) Provisional application No. 61/810,915, filed on Apr. 11, 2013.

(51) Int. Cl. H01J 45/00

(52) U.S. Cl. CPC H01J 45/00
USPC 310/306

(57) ABSTRACT

In one aspect of the invention, a thermionic energy converter comprises an anode, a cathode spaced from the anode to define a gap therebetween, and molecular hydrogen incorporated into the gap.

### CROSS-REFERENCE TO RELATED PATENT APPLICATION

This application claims priority to and the benefit of, pursuant to 35 U.S.C. §119(e), U.S. Provisional Patent Application Ser. No. 61/810,915, filed Apr. 11, 2013, entitled “ENHANCED THERMIONIC ENERGY CONVERTER AND APPLICATIONS OF SAME”, by William F. Paxton et al., which is incorporated herein in its entirety by reference.

Some references, which may include patents, patent applications, and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference was individually incorporated by reference. In terms of notation, hereinafter, “[n]” represents the nth reference cited in the reference list. For example, [12] represents the 12th reference cited in the reference list, namely, W. F. Paxton, M. Howell, W. P. Kang, and J. L. Davidson, “Influence of hydrogen on the thermionic electron emission from nitrogen-incorporated polycrystalline diamond films,” Journal of Vacuum Science & Technology B: Microelectronics and Nanometer Structures, vol. 30, p. 021202, 2012.

### STATEMENT AS TO RIGHTS UNDER FEDERALLY-SPONSORED RESEARCH

The invention was made with government support under Grant No. NSF EPS 1004083 awarded by the National Science Foundation. The government has certain rights in the invention.

### FIELD OF THE INVENTION

The invention relates generally to energy conversion, and more particularly to an enhanced thermionic energy converter and applications of the same.

### BACKGROUND OF THE INVENTION

The background description provided herein is for the purpose of generally presenting the context of the present invention. Work of the presently named inventors, to the extent it is described in this background section, as well as aspects of the description that may not otherwise qualify as prior art at the time of filing, are neither expressly nor impliedly admitted as prior art against the present invention.

Thermionic energy conversion (TEC) is a technique that allows for the efficient conversion of thermal energy directly into electrical energy [1-5]. TEC is based on the widely understood physical principal of thermionic emission which describes the thermal emission of electrons from a heated cathode. As a cathode is heated above zero Kelvin, it can be predicted, based on Fermi-Dirac statistics that some of the cathode's electrons will have energies equal to or greater than the cathode's work function. The work function is the energy required for an electron to be emitted into the vacuum. This process can be described by the following Richardson equation [6, 7].

J=AT²e^{-Φ/kT} (1)

where J=current density (A/cm²); A=Richardson constant (A/K² cm²); T=temperature (K); Φ=work function (eV); and k=Boltzmann constant (eV/K). From the Richardson equation (1) that high thermionic emission current densities can be achieved by a material with a high Richardson constant and a low work function.

There are several possible ways to conceptualize a thermionic energy converter. One possible conceptualization was presented by R. S. Rasor who describes a thermionic energy converter as a thermodynamic heat engine cycle similar to a modified Rankine cycle [1]. All heat engines require a working fluid which Rasor portrays as electrons. The function of the cathode in such a heat engine is to act as an “electron boiler”, while the anode functions as the electron condenser. These two components result in an electric pressure (i.e., voltage) difference which produces work. The difference between the heat of vaporization of the electrons from the emitter and the heat of condensation of the electrons into the collector directly equals the amount of electrical work produced per electron [1].

During the mid-20^{th} century, much research went into thermionic energy converters in an attempt to achieve an efficient means of converting thermal energy into electricity with limited success. Some approaches did achieve useful output currents of 3 to 20 A/cm² at output voltages between 0.5V to 1.5V and operated continuously for 5 or more years but were required to operate at several thousand degrees to achieve this performance [1, 5]. Unfortunately these devices were handicapped by low operational efficiencies (about 20%) due to material limitations leading many researchers to de-emphasize thermionic converters in favor of other conversion techniques. At the time of this technology's peak interests, the best available materials had work functions between 4-5 eV which corresponds to useable current densities only at temperatures exceeding 2000° C. Although effective work functions could be lowered, for example, by modifying the surface with cesium, these adsorbate techniques typically do not hold up to high fields or long operation times. Also, the thermal sources required for the very high operation temperatures of past TEC devices (e.g., nuclear pile), limited this technology to unmanned space operations due to safety considerations [1, 5].

Past implementations of thermionic energy converters utilized tungsten cathodes with cesium gas fed into the cathode-anode gap [4, 5, 16-19]. The cesium served two purposes. Tungsten has a relatively high work function requiring high temperatures (in excess of 2000° C.) in order to achieve practical thermionic current densities. The work function can be lowered by “cesiating” the tungsten surface [4, 5, 16]. The effects of the cesium rapidly diminish during operation as the tungsten outgases when is heated to operating temperatures. By incorporating cesium gas into the interelectrode gap, the cesium in the tungsten could be constantly replenished allowing for stable operation [4]. In addition to enhancing the surface chemistry, operation of tungsten cathodes in a cesium vapor environment (rather than a vacuum) has been shown to favorable affect the electron transport from the cathode to the anode.

The high emission currents required to produce necessary output power levels often result in space charge effects. Space charge effects are due to the negatively charged electrons traversing the cathode-anode gap which cancel out a portion of the electric field between the cathode and anode. More electrons present in the gap equates to the more of this electric field being canceled, further suppressing the emission current. This performance limiting effect can be mitigated (or even eliminated) through the presence of positive cesium ions in the cathode-anode gap. One method to introduce these ions is through surface ionization. When a tungsten cathode is heated to temperatures in excess of 1200° C., Langmuir and Kingdon showed that all cesium atoms that strike it are ionized resulting in positively charged cesium ions [4, 20]. These positive charges present adjacent to the emitter surface will cancel out the negative charges of the electrons, reducing the space charge effect. Cesium ions can also be produced by collision of cesium atoms with the thermionically emitted electrons from the cathode [19]. In order for ionization to occur, electron temperatures greater than 2500° C. are required [21].

In addition, previous work by Nemanich et at has demonstrated the operation of diamond thermionic cathodes in a high pressure (up to 700 mTorr) methane environment greatly increases the emission performance compared to operation in a vacuum environment [23]. However, methane is not a suitable candidate for increasing the performance of a diamond TEC, since operation in methane will result in the accumulation of non-diamond carbonaceous content, akin to soot, preventing the long term operation of such a configuration.

Therefore, a heretofore unaddressed need exists in the art to address the aforementioned deficiencies and inadequacies.

### SUMMARY OF THE INVENTION

In one aspect of the invention, a thermionic energy converter comprises an anode; a cathode spaced from the anode to define a gap therebetween; and molecular hydrogen incorporated into the gap.

In one embodiment, at least one of the anode and the cathode is formed of diamond. In one embodiment, at least one of the anode and the cathode comprises a nitrogen-incorporated diamond film.

In one embodiment, the cathode is exposed to the molecular hydrogen such that H bonds and/or C—H bonds are formed on the surface of the cathode.

In one embodiment, the molecular hydrogen incorporated into the gap is operably at a predetermined pressure.

In one embodiment, electrons emitted from the cathode and traversing towards the anode are of a function of temperature at the cathode.

In another aspect of the invention, a thermionic energy converter, comprises molecular hydrogen; and a cathode of diamond exposed to the molecular hydrogen.

In one embodiment, the thermionic energy converter further comprises an anode spaced from the cathode to define a gap therebetween.

In one embodiment, at least one of the anode and the cathode comprises a nitrogen-incorporated diamond film.

In one embodiment, the molecular hydrogen is incorporated into the gap, operably at a predetermined pressure.

In one embodiment, H bonds and/or C—H bonds are formed on the surface of the diamond of the cathode.

In one embodiment, electrons emitted from the cathode of diamond are of a function of temperature at the cathode.

In yet another aspect of the invention, a thermionic energy converter, comprises hydrogen.

In one embodiment, the thermionic energy converter further comprises a cathode of diamond exposed to the hydrogen.

In one embodiment, the thermionic energy converter further comprises an anode spaced from the cathode to define a gap therebetween.

In one embodiment, the thermionic energy converter further comprises the hydrogen is incorporated into the gap, operably at a predetermined pressure.

In a further aspect of the invention, a thermionic energy converter includes a gaseous species; and a cathode exposed to the gaseous species so as to form H bonds and/or C—H bonds on the surface of the cathode. In one embodiment, the cathode is formed of diamond.

In one embodiment, the thermionic energy converter further includes an anode spaced from the cathode to define a gap therebetween.

In one embodiment, the gaseous species contains hydrogen.

In one embodiment, the gaseous species is incorporated into the gap, operably at a predetermined pressure.

In one embodiment, electrons emitted from the cathode are of a function of temperature at the cathode.

In yet a further aspect of the invention, an apparatus for thermal energy conversion comprises at least one thermionic energy converter as recited above.

In one aspect of the invention, a thermal to electrical energy conversion device includes an anode; a cathode for electron emission; and hydrogen incorporated into a gap defined between the anode and the cathode.

In one embodiment, the cathode is exposed to the hydrogen.

In one embodiment, at least one of the anode and the cathode comprises a nitrogen-incorporated diamond film.

In one embodiment, the hydrogen incorporated into the gap is operably at a predetermined pressure.

In one embodiment, electrons emitted from the cathode and traversing towards the anode are of a function of temperature at the cathode.

In another aspect of the invention, an electron emission device comprises a gaseous species; and a cathode exposed to the gaseous species so as to form C—H bonds on the surface of the cathode.

In one embodiment, the electron emission device further comprises an anode spaced from the cathode to define a gap therebetween.

In one embodiment, at least one of the anode and the cathode is formed of diamond.

In one embodiment, the gaseous species contains hydrogen. In one embodiment, the gaseous species is incorporated into the gap, operably at a predetermined pressure.

In one embodiment, electrons emitted from the cathode are of a function of temperature at the cathode.

In yet another aspect of the invention, a device operated by electron emission, comprises hydrogen.

In one embodiment, the device further comprises a cathode of diamond exposed to the hydrogen.

In one embodiment, the device further comprises an anode spaced from the cathode to define a gap therebetween.

In one embodiment, the hydrogen is incorporated into the gap, operably at a predetermined pressure.

In a further aspect of the invention, a method for thermal energy conversion, comprises providing an anode and a cathode spaced from the anode to define a gap therebetween, wherein the cathode is formed of diamond; incorporating hydrogen into the gap; and heating the cathode at a desired temperature.

In one embodiment, the cathode comprises a nitrogen-incorporated diamond film.

In one embodiment, the hydrogen incorporated into the gap is operably at a predetermined pressure.

In one embodiment, electrons emitted from the cathode are of a function of the desired temperature.

In a further aspect of the invention, a method for electron emission comprises exposing a cathode to a gaseous species so as to form H bonds and/or C—H bonds on the surface of the cathode. In one embodiment, the gaseous species contains hydrogen.

In one embodiment, the method further comprises heating the cathode at a desired temperature.

In one embodiment, electrons emitted from the cathode are of a function of the desired temperature.

These and other aspects of the invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 shows schematically a thermionic energy converter according to one embodiment of the invention.

FIG. 2 shows comparison of the thermionic emission testing results from Test No. 1 and Test No. 2 of an as-grown sample before hydrogenation. Test No. 1 was an as-grown diamond sample and the thermionic emission current was observed to increase with temperature according to the Richardson equation until about 800° C. upon which the emission current began to decrease. Test No. 2 was performed on the same sample after a cool down period. No emission current above the noise level was observed up to a maximum testing temperature of 800° C. The solid line represents the fit to the Richardson equation of Test No. 1 data.

FIG. 3 shows comparison of the thermionic emission testing results from Test No. 1, Test No. 2, and Test No. 3. The electron emission current from the sample after hydrogenation is significantly higher than the previous runs. The solid line represents the fit of Test No. 3 to the Richardson Equation.

FIGS. 4A-4C show isothermal emission current behavior of an as-grown diamond film with hydrogen leaked in for the temperature 600° C., 625° C., and 650° C. The blue data represents the current while the red data represents the pressure in the chamber. For all graphs, it can clearly be seen that there is an increase in emission current when the hydrogen pressure is increased in the chamber.

FIGS. 5A-5C show isothermal emission current behavior of a hydrogenated diamond film with hydrogen leaked in for the temperature 600° C., 625° C., and 650° C. The blue data represents the current while the red data represents the pressure in the chamber. For all graphs, it can clearly be seen that there is an increase in emission current when the hydrogen pressure is increased in the chamber.

FIG. 6 shows an example of the residual plot performed for all data runs which allows for direct calculation of the increase in current upon hydrogen being leaked into the chamber.

FIG. 7 shows a plot of the emission current increase in the influence of hydrogen gas as a function of the current before the start of the leak-in (baseline current). A clear relationship can be seen where the magnitude of increase increases with baseline current. Two possible trend lines were found to describe this relationship: linear and power.

FIG. 8 shows plots of the emission current vs. temperature after the third testing runs for the as-grown (a) and hydrogenated (b) diamond sample.

FIG. 9 shows potential output current of an all diamond thermionic energy converter with molecular hydrogen as the interelectrode gas at a pressure of 5.5 μTORR.

FIG. 10 shows potential output power of an all diamond thermionic energy converter with molecular hydrogen as the interelectrode gas at a pressure of 5.5 μTorr.

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

As used herein, “around”, “about”, “substantially” or “approximately” shall generally mean within 20 percent, preferably within 10 percent, and more preferably within 5 percent of a given value or range. Numerical quantities given herein are approximate, meaning that the term “around”, “about” “substantially” or “approximately” can be inferred if not expressly stated.

The description will be made as to the embodiments of the invention in conjunction with the accompanying drawings. In accordance with the purposes of this invention, as embodied and broadly described herein, this invention, in one aspect, relates to an enhanced thermionic energy converter and applications of the same.

In certain embodiments, a thermionic energy converter has a cathode of nitrogen-incorporated diamond exposed to a hydrogen environment. The thermionic energy converter can achieve total energy conversion efficiencies of 90% of the Carnot limit, which is a vast improvement over current technologies [2, 3].

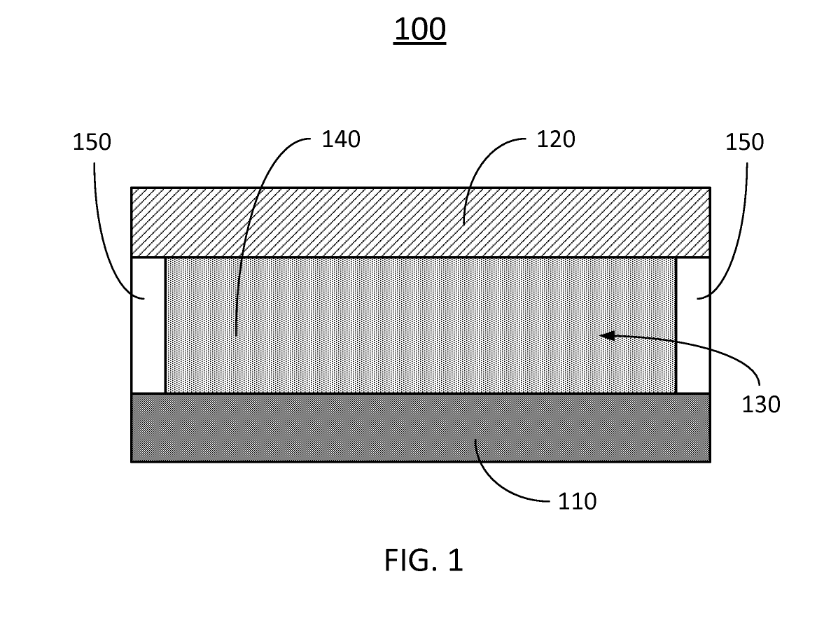

Referring to FIG. 1, a thermionic energy converter 100 is shown according to one embodiment of the invention. Generally, the thermionic energy converter 100 includes an anode 110, a cathode 120 spaced from the anode 110 to define a gap 130 therebetween, and molecular hydrogen 140 incorporated into the gap 130. In certain embodiments, the molecular hydrogen incorporated into the gap 130 is operably at a predetermined pressure. In certain embodiments, both the anode 110 and the cathode 120 are formed of diamond. In certain embodiments, one of the anode 110 and the cathode 120 is formed of diamond, while the other of the anode 110 and the cathode 120 is formed of a non-diamond material. In certain embodiments, at least one of the anode 110 and the cathode 120 comprises a nitrogen-incorporated diamond film. In certain embodiments, both the anode 110 and the cathode 120 are formed of non-diamond materials.

In this exemplary embodiment, each of the anode 110 and the cathode 120 is a film, and the anode 110 and the cathode 120 are parallel to each other. It should be noted that other types of the anode and the cathode can also be utilized to practice the invention.

In operation, as thermal energy is imparted to the cathode 120, electrons with sufficient energy thermionically emit from the surface of the cathode 120 and accelerate through the molecular hydrogen incorporated gap 130 towards the anode 110 at which they are collected. The electrons emitted from the cathode 120 and traversing towards the anode 110 are of a function of temperature at the cathode 120. The emitted electrons can be utilized to drive a load as they are cycled back to the cathode 120 through the electrical connections.

According to the invention, the molecular hydrogen incorporated into the gap plays an important role in enhancing thermionic emission of the cathode of diamond, and thus improving the low temperature (less than 1000° C.) thermionic emission performance of diamond films. The operation of diamond thermionic cathodes in a low pressure hydrogen environment not only potentially allows for better thermionic emission performance to be achieved, but also provides a better understand of the role hydrogen on the electronic properties of diamond.

Hydrogen has been shown to greatly enhance the electrical properties of diamond by increasing its conductivity and inducing a negative electron affinity, both of which are favorable for thermionic emission [8-11]. The implementation of such a cathode has been hindered by the relatively low temperature ceiling at which they can operate. The Richardson equation (1) indicates that emission current should follow an exponential increasing trend with increasing temperature. However, previous studies have observed the emission current from diamond films begin to decrease at temperatures exceeding 700° C. rather than continue to increase as predicted by the Richardson equation [12-14]. This deviation from the Richardson equation is attributed to desorption of hydrogen from the diamond surface.

Hydrogen interaction with the diamond surface has been shown to be somewhat analogous to the interaction of cesium of tungsten. The exposure of diamond films to hydrogen plasma treatments creates polarized C—H surface bonds which lower diamond's electron affinity to negative levels that directly correlates to a lower work function [22]. Thus, hydrogen containing gaseous species is the most suitable candidates to enhance the thermionic emission performance of diamond.

Though the molecular hydrogen anion is the simplest of all molecular anion, it has proven to be one of the most hotly debated topics in molecular physics over the past 50 years. It is not until recently that the existence of the molecular hydrogen anion has become certain [24, 25]. The earliest calculations on the molecular hydrogen anion were performed by Eyring and colleagues, who mathematically demonstrated that the energy required to dissociate H₂⁻ into H and H⁻ was positive. This positive energy requirement to dissociate means that energy must be added to the system in order for the reaction to occur, thus implying H₂⁻ to be stable [26, 27]. The stability of the molecular hydrogen anion would appear to indicate H₂ to have a positive electron affinity. However, all previous attempts to calculate the electron affinity of molecular hydrogen have been in disagreement with each other with a large range of electron affinity values reported, both negative and positive [27-30]. Experimental observation H₂⁻ has been reported several times, beginning with Khvostenko and Dukel'skii in 1957 [31, 32], though results have been met with skepticism due to the experimental difficulty of deciphering H₂⁻ from the sable atomic deuterium anion [31]. It has not been until recently that the existence and behavior been experimentally observed with enough confidence to be widely accepted by the scientific community [25, 31, 33]. It is clear that many challenges still persist in the understanding of molecular hydrogen making it difficult to predict its influence on the thermionic emission from diamond films.

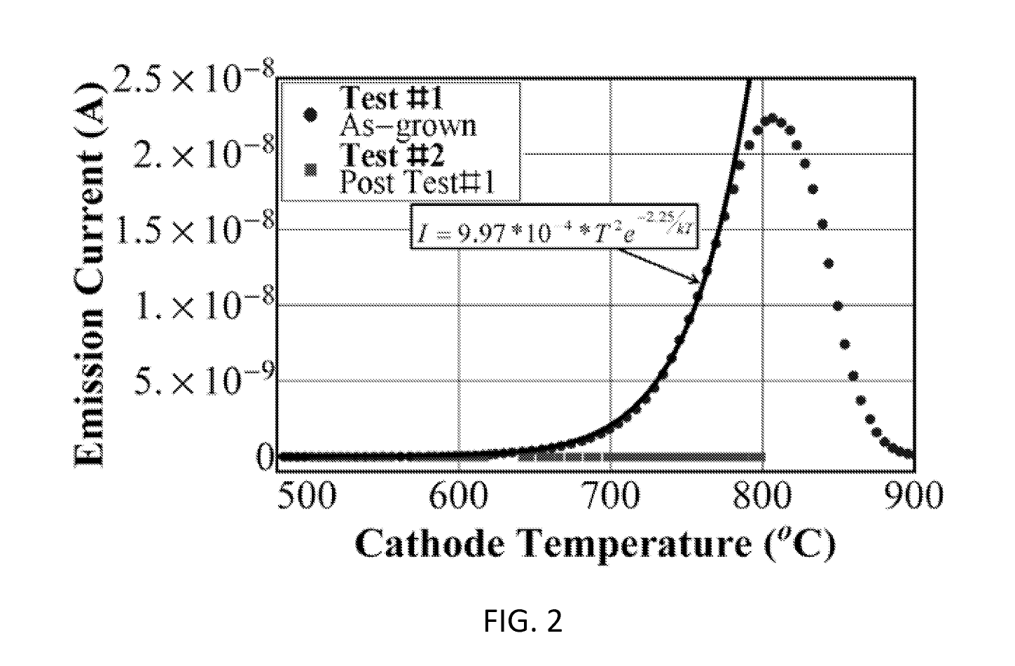

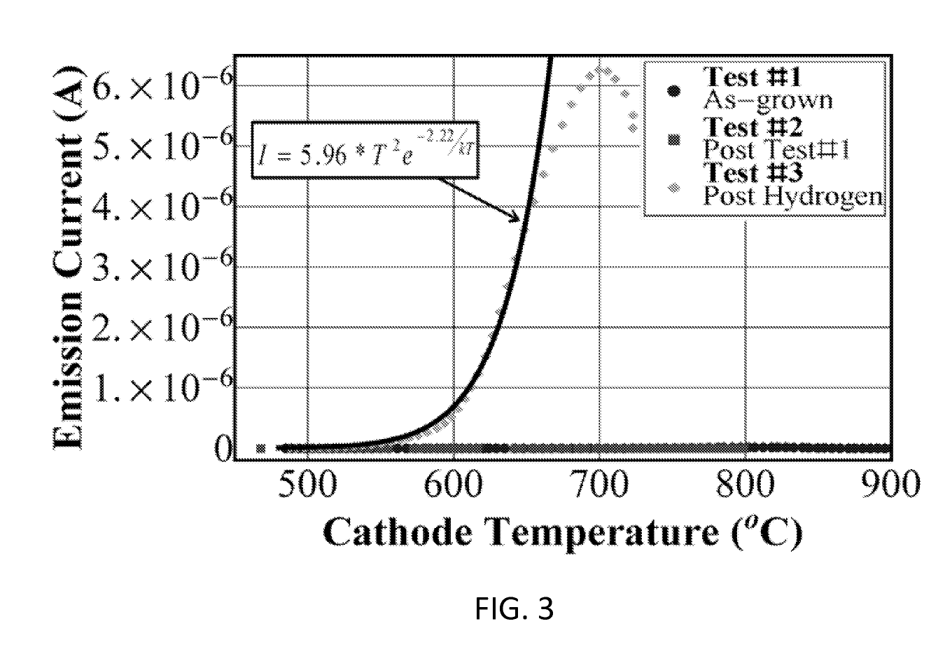

In the disclosure, the influence of molecular hydrogen (H₂) on the thermionic emission from diamond is examined according to certain embodiments of the invention. In addition to the examples described in the disclosure, the inventors have also reported that the exposure of diamond cathodes to a low energy hydrogen plasma drastically enhances the thermionic emission current from diamond films [12], which tested the thermionic emission current as a function of temperature from an as-grown diamond sample. The emission current was observed to closely follow the Richardson equation at temperatures up to 800° C. after which, the emission current began to decrease with increasing temperature. Testing continued up to 900° C. at which time, very little emission current was observed above background. Retesting of the sample did not measure any emission current above the background. The results from these first two tests are shown in FIG. 2. The sample was then exposed to a low energy hydrogen plasma and tested a third and final time. It was observed that the hydrogenation treatment not only showed recovery of the sample's emission current but that the hydrogenated sample was able to achieve emission current levels four orders of magnitude higher than the as-grown sample, as shown in FIG. 3 [12]. These results indicate that hydrogen is responsible for the high thermionic emission performance of diamond cathodes [12, 15].

In another aspect of the invention, a thermionic energy converter comprises molecular hydrogen; and a cathode of diamond exposed to the molecular hydrogen. In addition, the thermionic energy converter may also have an anode spaced from the cathode to define a gap therebetween. In one embodiment, C—H bonds are formed on the surface of the diamond of the cathode.

In one embodiment, the molecular hydrogen is incorporated into the gap, operably at a predetermined pressure.

In one embodiment, electrons emitted from the cathode of diamond are of a function of temperature at the cathode.

In yet another aspect of the invention, a thermionic energy converter comprises hydrogen. The thermionic energy converter may further have a cathode of diamond exposed to the hydrogen, and an anode spaced from the cathode to define a gap therebetween. In one embodiment, the hydrogen is incorporated into the gap, operably at a predetermined pressure.

In a further aspect of the invention, a thermionic energy converter includes a gaseous species; and a cathode exposed to the gaseous species so as to form H bonds and/or C—H bonds on the surface of the cathode. In one embodiment, the thermionic energy converter further includes an anode spaced from the cathode to define a gap therebetween.

In one embodiment, the gaseous species contains hydrogen. In one embodiment, the gaseous species is incorporated into the gap, operably at a predetermined pressure.

In yet a further aspect of the invention, an apparatus for thermal energy conversion comprises at least one thermionic energy converter as recited above.

In one aspect of the invention, a thermal to electrical energy conversion device includes an anode; a cathode for electron emission; and hydrogen incorporated into a gap defined between the anode and the cathode.

In one embodiment, the cathode is exposed to the hydrogen. In one embodiment, the hydrogen incorporated into the gap is operably at a predetermined pressure.

In one embodiment, electrons emitted from the cathode and traversing towards the anode are of a function of temperature at the cathode.

In another aspect of the invention, an electron emission device comprises a gaseous species; and a cathode exposed to the gaseous species so as to form H bonds and/or C—H bonds on the surface of the cathode. In one embodiment, the electron emission device further comprises an anode spaced from the cathode to define a gap therebetween.

In one embodiment, the gaseous species contains hydrogen. In one embodiment, the gaseous species is incorporated into the gap, operably at a predetermined pressure.

In one embodiment, electrons emitted from the cathode are of a function of temperature at the cathode.

In yet another aspect of the invention, a device operated by electron emission, comprises hydrogen. In certain embodiments, the device further comprises a cathode of diamond exposed to the hydrogen, and an anode spaced from the cathode to define a gap therebetween. In one embodiment, the hydrogen is incorporated into the gap, operably at a predetermined pressure.

In a further aspect of the invention, a method for thermal energy conversion, comprises providing an anode and a cathode spaced from the anode to define a gap therebetween, wherein the cathode is formed of diamond; incorporating hydrogen into the gap; and heating the cathode at a desired temperature.

In one embodiment, the cathode comprises a nitrogen-incorporated diamond film.

In one embodiment, the hydrogen incorporated into the gap is operably at a predetermined pressure.

In one embodiment, electrons emitted from the cathode are of a function of the desired temperature.

In a further aspect of the invention, a method for electron emission comprises exposing a cathode to a gaseous species so as to form H bonds and/or C—H bonds on the surface of the cathode. In one embodiment, the gaseous species contains hydrogen.

In one embodiment, the method further comprises heating the cathode at a desired temperature.

In one embodiment, electrons emitted from the cathode are of a function of the desired temperature.

Without intent to limit the scope of the invention, examples and their related results according to the embodiments of the present invention are given below. Note that titles or subtitles may be used in the examples for convenience of a reader, which in no way should limit the scope of the invention. Moreover, certain theories are proposed and disclosed herein; however, in no way they, whether they are right or wrong, should limit the scope of the invention so long as the invention is practiced according to the invention without regard for any particular theory or scheme of action.

### Experimental

Polycrystalline nitrogen-incorporated diamond films were again deposited via microwave plasma enhance deposition. The samples were tested in a vacuum testing chamber equipped with a turbomolecular pumping stand capable of pumping the chamber to pressures on the order of 1×10⁻⁷ Torr. A tank of ultra-high purity hydrogen was connected to the chamber via a leak valve. This chamber was equipped with a residual gas analyzer (RGA) to allow for direct verification of the composition of the gasses fed into the chamber. Verification that only hydrogen was being leaked into the chamber was made when the leak valve was opened and only a hydrogen peak was seen while all other gases remained unchanged. During testing, the RGA was shut off to prevent the emission of stray electrons that could be collected by the ammeter.

Testing included isothermally heating a diamond sample to five temperatures for an extended period of time: 600° C., 625° C., 650° C., 675° C., and 700° C. using a PID control loop. The film was resistively heated and the temperature was observed by an externally positioned pyrometer. Emission current was collected by an electrically isolate anode positioned about 1 cm from the tested sample biased at 200V. At each temperature, the samples were first left to operate for a short period of time to establish a baseline trend of the emission current. Hydrogen gas was then fed into the chamber until the pressure at the pump read about 5.5 μTorr (N₂ equivalent). This pressure was maintained for a period of about 1 minute after which, the valve was closed and the pressure rapidly decreased back down to 1×10⁻⁷ levels. This leak in process was performed twice at each temperature. The whole process was first performed three times on an as-grown sample (three runs, five temperatures per run). Upon completion of the third run, the LABVIEW program was stopped, the data saved, and the current vs. temperature program was started with the sample already heated to 700° C. The sample was then heated to about 900° C. in roughly five degree increments with the current constantly monitored. During the current vs. temperature test, the leak valve was left open allowing for hydrogen gas to be constantly fed into the chamber maintaining pressure of about 5.5×10⁻⁶ Torr (N₂ equivalent) measured at the pump. This process was meant to determine if a hydrogen environment could increase the operational temperature of diamond thermionic emitters. Following the current vs. temperature test, the sample was cooled down, hydrogenated in the MPCVD chamber, and the whole process performed again. After the second current vs. temperature test, a final isothermal test was performed at the five testing temperatures.

### Results and Discussion

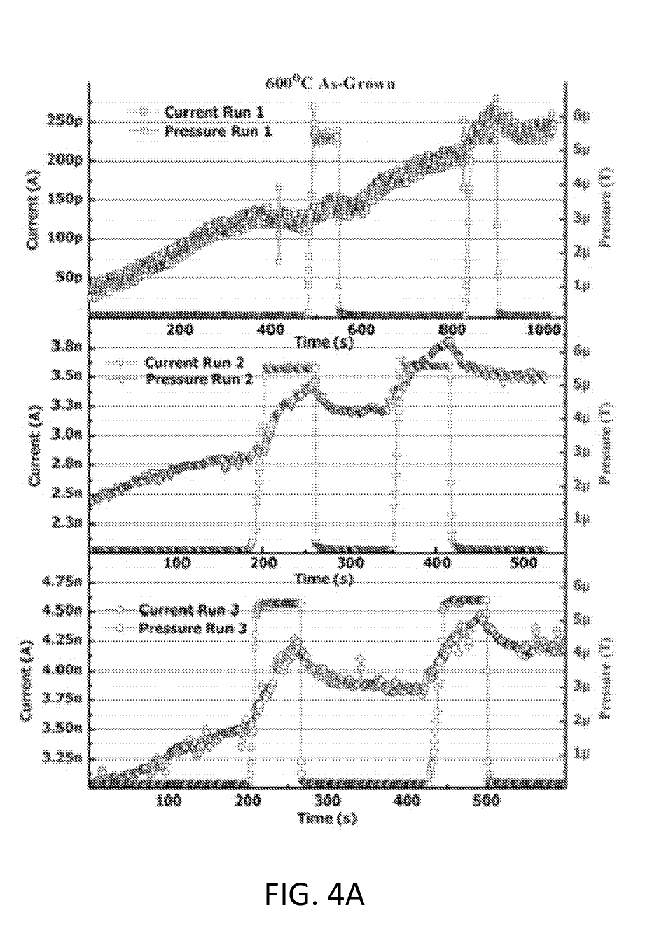

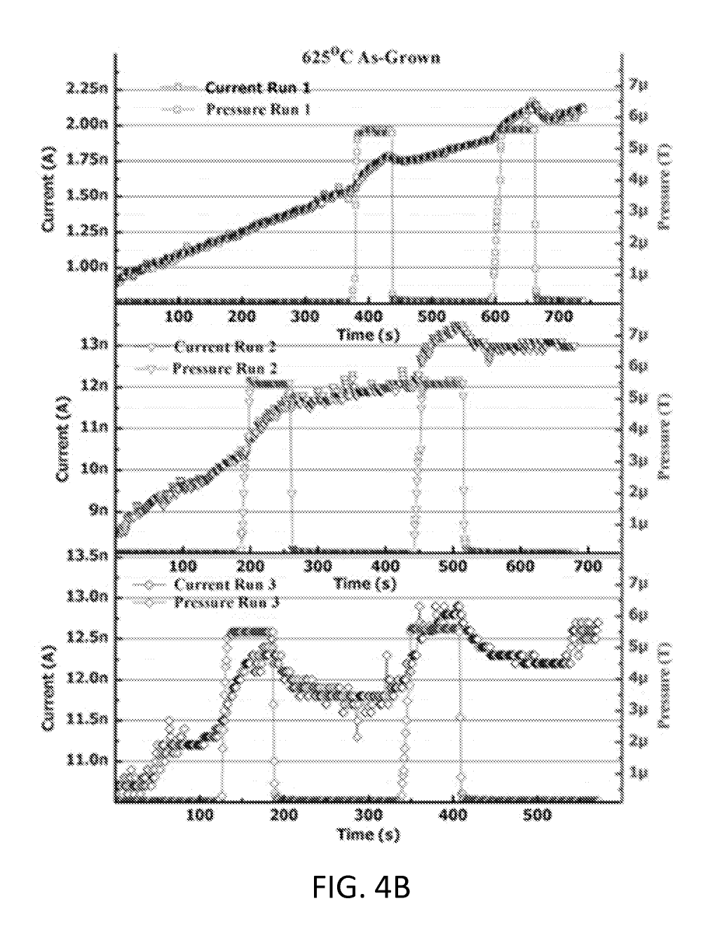

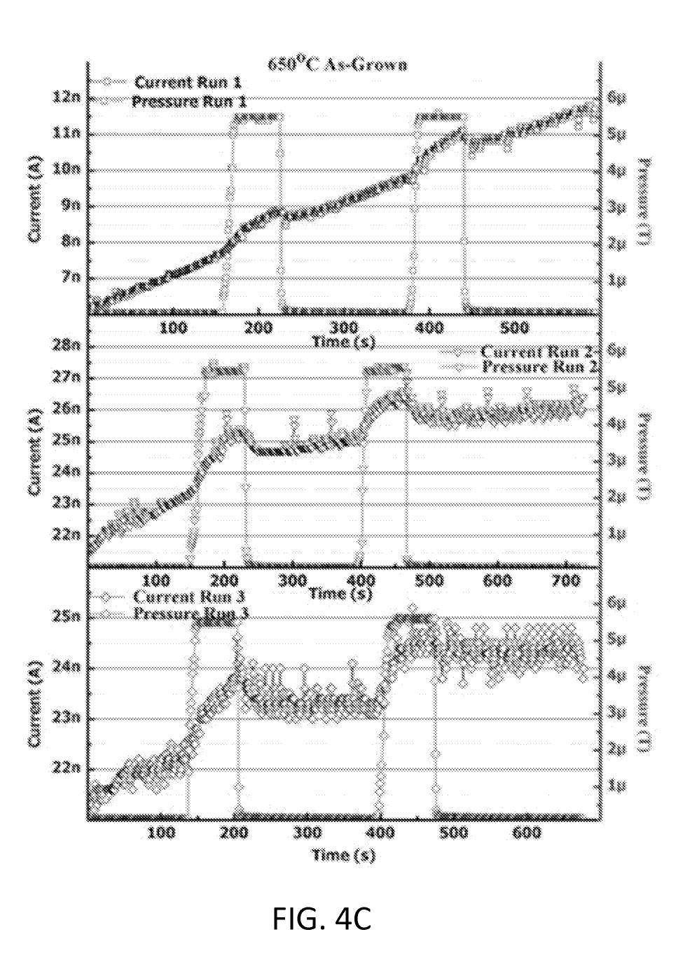

Emission current and pressure plotted against time for the as-grown sample are shown in FIG. 4. It is clearly shown that leaking in hydrogen has a positive effect on the emission current at every temperature for each of the three as-grown runs. The emission current clearly increases from the baseline trend when hydrogen is let flow into the chamber and decreases back to the baseline trend when the hydrogen is shut off.

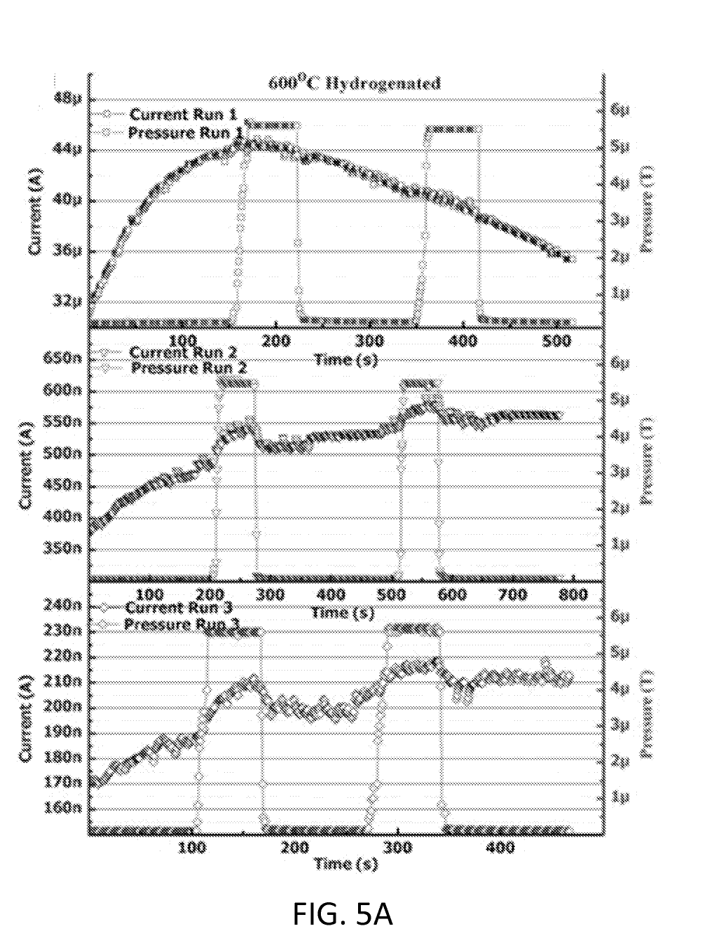

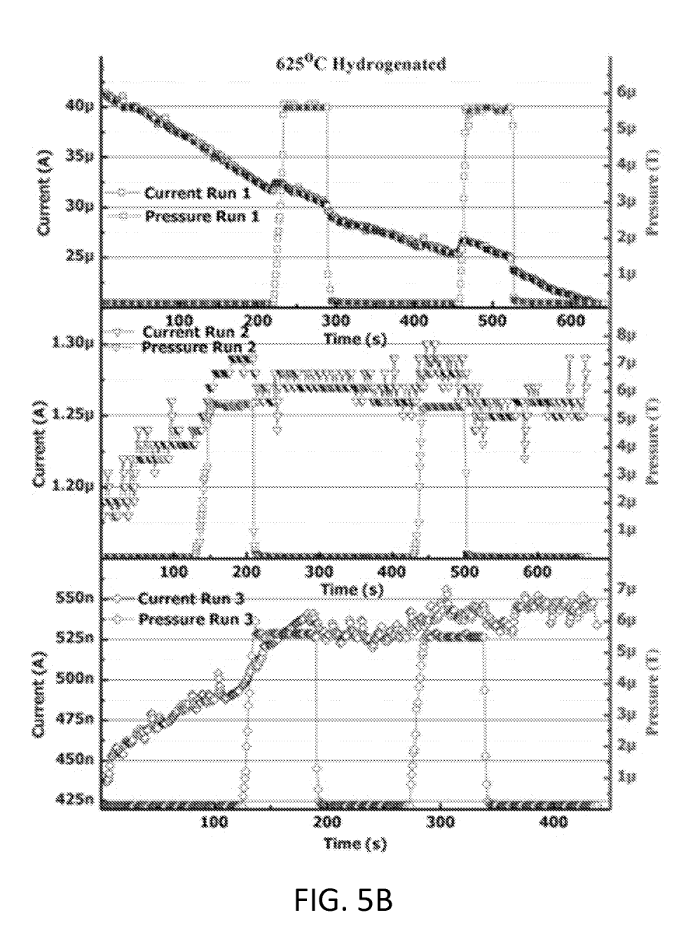

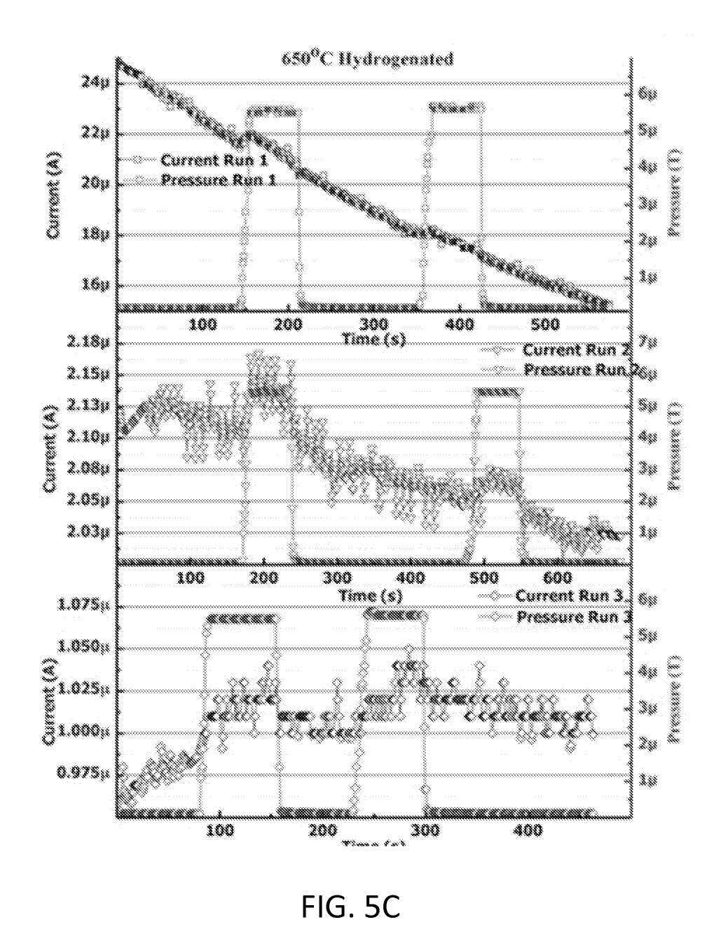

Isothermal testing of the sample post hydrogenation treatment demonstrated a similar response to the leaking of hydrogen to the as-grown sample but with much higher emission current values, as shown in FIG. 5. Again, the data from the higher temperatures is not shown as the background current variations were too large to decipher any current response to hydrogen.

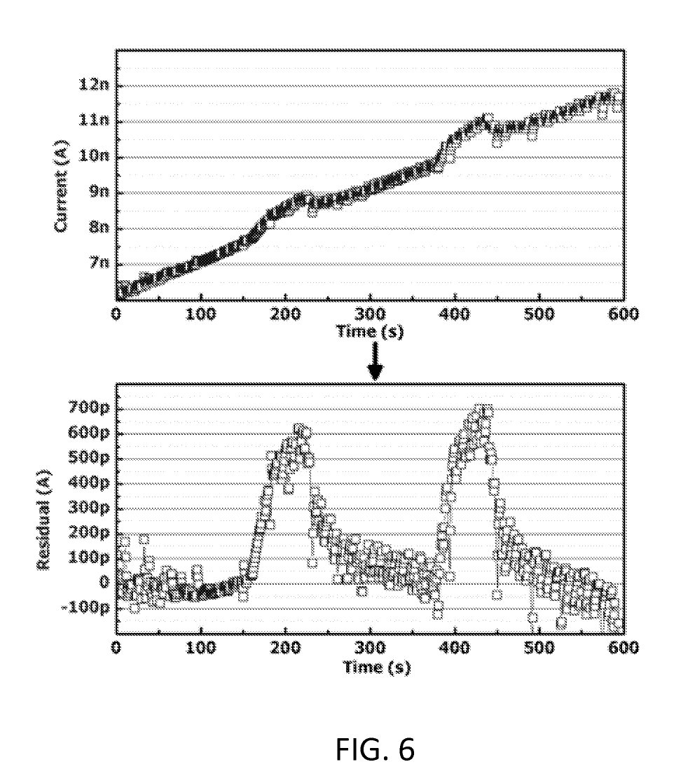

Analysis of the response to hydrogen for both the as-grown and hydrogenated testing runs was difficult due to the transient nature of the background. To allow for more accurate quantification of the current increase, a residual plot was taken of the data. A residual plot includes determining the trend of the background and subtracting each data point from the trend line similar to a linear transformation. An example of this transformation is shown in FIG. 6 for the 650° C. Run 1 data.

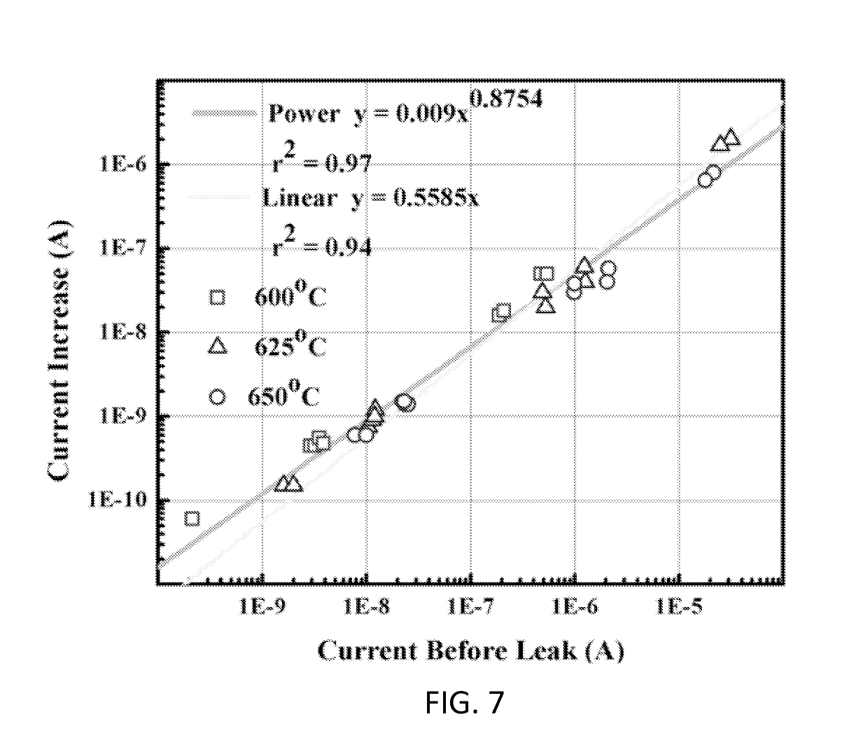

A plot of the current increase vs. baseline current (current before leak-in) is shown in FIG. 7, which indicates a definite relationship between baseline current and the current increase in that higher baseline current equates to a higher increase in current in the presence of hydrogen. Two possible trend lines have been found that describe the observed the data, one linear and one power.

Though the power trend line has a higher coefficient of determination (R²), it is unlikely that a physical model can be derived with which it agrees. This is because both the dependent and independent variables are in units of Amperes. Examination of the equation for the power trend lines implies that there is some constant (units unknown) that is multiplied by amperes to the 0.8754 power. As the result of this product must be in Amperes, the constant must have units of amperes raised to the 0.1246 power which is highly improbable. A more likely description is the linear trend line.

The linear fit to the data shown in FIG. 4 implies the baseline current can be related to the current increase by means of a simply unit-less constant. Further the calculated linear trend line has a y-intercept of 0. This follows intuition because when there is no baseline current, which happens at OK as described by the Richardson equation. There is no increase in emission current.

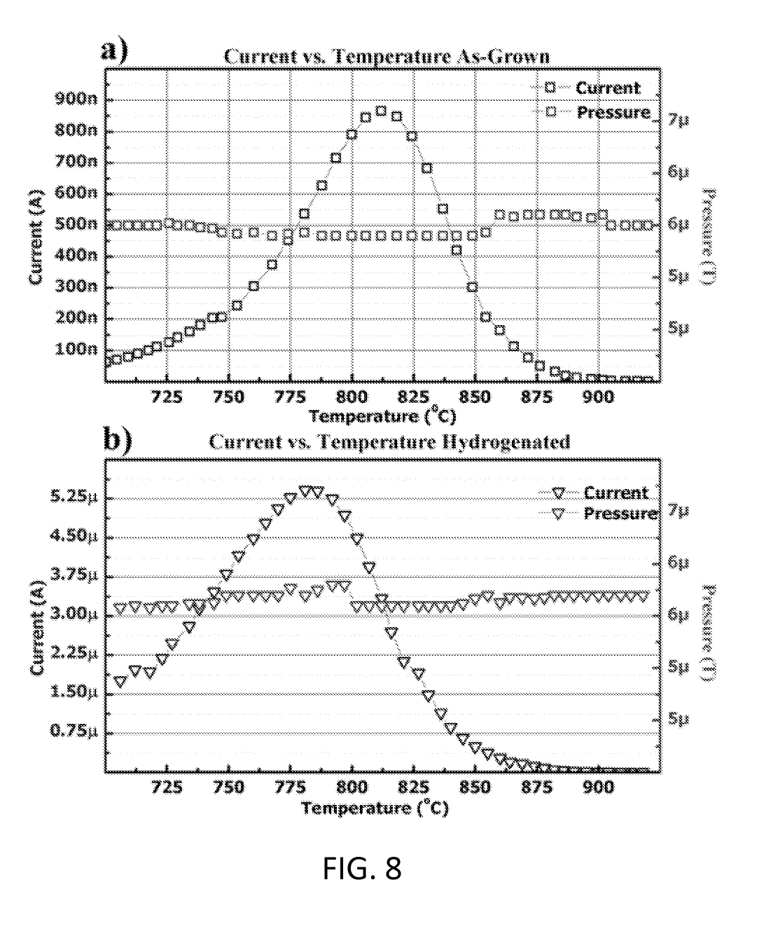

Two emission current versus temperature tests were performed one after the third as-grown run and also after the third hydrogenated run, both beginning at 700° C. and continuing up to 900° C. The hydrogen pressure in the chamber was constantly maintained at about 5.5×10⁻⁶ Torr (N₂ equivalent) throughout both tests. From FIG. 8a it can be seen that the as-grown sample reached its maximum emission current levels at a temperature around 815° C. which is slightly higher than the value seen for the previously described as-grown emission tests. FIG. 8b indicates that the maximum emission current was achieved at about 780° C. This is a significant improvement over the 700° C. value found in the previous hydrogenated tests.

The above results indicate that the incorporation of hydrogen gas into the gap between the cathode and anode does indeed have an enhancing effect. The positive correlation between baseline current and emission current increase shown in FIG. 7 is evidence that the reaction is a result of the electrons traversing the vacuum gap rather than direct interaction between the heated cathode and the molecular hydrogen. Attempts to hydrogenate diamond with molecular hydrogen have only proven successful at temperatures in excess of 400° C. [34, 35]. The lack of temperature dependence on the emission current increase shown in the overlap of data points at different temperatures in FIG. 7 implies that similar dissociation rates of molecular hydrogen are occurring at all three temperatures. If this is the case, there are two possible mechanisms taking place that are in agreement with previously reported work.

The first possible explanation deals with the in-situ rehydrogenation of the diamond films. Recall that the beneficial effects hydrogen has on the thermionic emission from diamond films are due to atomic hydrogen bonding with the surface carbon atoms reducing the electron affinity. In the typical hydrogenation treatment, the atomic hydrogen results from the dissociation of molecular hydrogen into atomic hydrogen due to electron collisions. The electrons are stimulated by the microwaves in the MPCVD chamber such that they oscillate with high enough energy that when they collide with molecular hydrogen, it ionizes and splits into two hydrogen atoms. The atomic hydrogen then bonds with the diamond surface forming C—H bonds which are favorable for thermionic emission. This same effect could be happening when the diamond thermionic cathodes are in operation. As electrons are emitted from the diamond and accelerated towards the anode, they will likely collide with the hydrogen present. Fermi-Dirac statistics predicts that these electrons will have a large range of energies with some inevitably high enough to cause the molecular hydrogen to ionize and dissociate. Some of this atomic hydrogen will migrate to the diamond cathode filling the dangling surface bonds thus increasing the emission current. When the hydrogen is shut off and evacuated from the chamber, these new emission sites rapidly desorb following the Arrhenius equation causing the emission current to decrease back down to the baseline levels. If this is the case, then this effect should increase when more electrons are traversing the vacuum gap (higher emission current) which was observed as shown in FIG. 7.

The second possible explanation deals with the mitigation of space-charge effects. During testing, the cathode and anode are biased at a fixed potential different of 200V. Space charge effects arise when electrons begin traversing the gap between the cathode and anode. Each electron has a negative charge that cancels out some portion of the 200V potential difference; so higher emission current levels result in a larger portion of the potential being canceled. The lower the potential the cathode sees, the lower the EMF to accelerate electrons to the anode and thus a lower emission current. The operation of the diamond thermionic emission devices in a hydrogen atmosphere could possibly cancel out some of this effect through the ionization of the molecular hydrogen. The ionization of molecular hydrogen results in two products: electrons with a negative charge, and ionized hydrogen with a positive charge. The negatively charge electrons will be attracted to the anode while the positively charged ions will proceed to the cathode. From the cathodes perspective, this accumulation of positive ions at the cathode surface will resemble the positive bias originally applied canceling out some of the space-charge effects and increasing the emission current. As more emission current would result in the creation of more positive ions, it is expected that a higher increase in emission current upon exposure to hydrogen gas would be seen, which also agrees with the results shown in FIG. 7.

According to the invention, the exposure of diamond samples to hydrogen plasma is necessary in order to achieve high thermionic emission current levels at low temperatures (less than 1000° C.). In a conventional vacuum environment, the emission current was observed to degrade at temperatures below 700° C. However, the exposure of diamond samples to a low pressure molecular hydrogen environment not only results in increased thermionic emission current (compared to operation in vacuum) but also allows for the samples to operate at higher temperatures. According to the invention, the emission current increase linearly as a function of baseline vacuum emission current levels upon exposure to a hydrogen environment of 5.5 μTorr.

I_{increase}=0.56*I_{baseline} (2)

where I_{increase} is the thermionic emission current increase upon exposure to molecular hydrogen and I_{baseline} is emission current prior to the introduction of hydrogen. Additionally, according the invention a low pressure molecular hydrogen environment allowed hydrogenated diamond samples to operate at temperatures around 800° C. before beginning the typical decreasing trend with increasing temperature.

Accounting for all of these effects, it is possible to predict the performance of a thermionic energy converter with a nitrogen-incorporated cathode and anode. For the cathode, this analysis used the thermionic emission parameters (Richardson constant and work function) derived for a hydrogenated diamond sample calculated from the data points prior to the “roll off” trend. The anode used the thermionic emission parameters for the low temperature operation of an as-grown diamond sample. To increase the performance, this analysis utilized the performance enhancing effects operation in a 5.5 μTorr hydrogen environment was shown. Thus, equation (2) was used to predict the increased thermionic emission current and the energy conversion performance was calculated up to temperatures just exceeding 800° C. To simplify the calculations, the thermionic emission conversion performance was assumed to have ideal electrical contacts and a load resistance that perfectly matches the output characteristics.

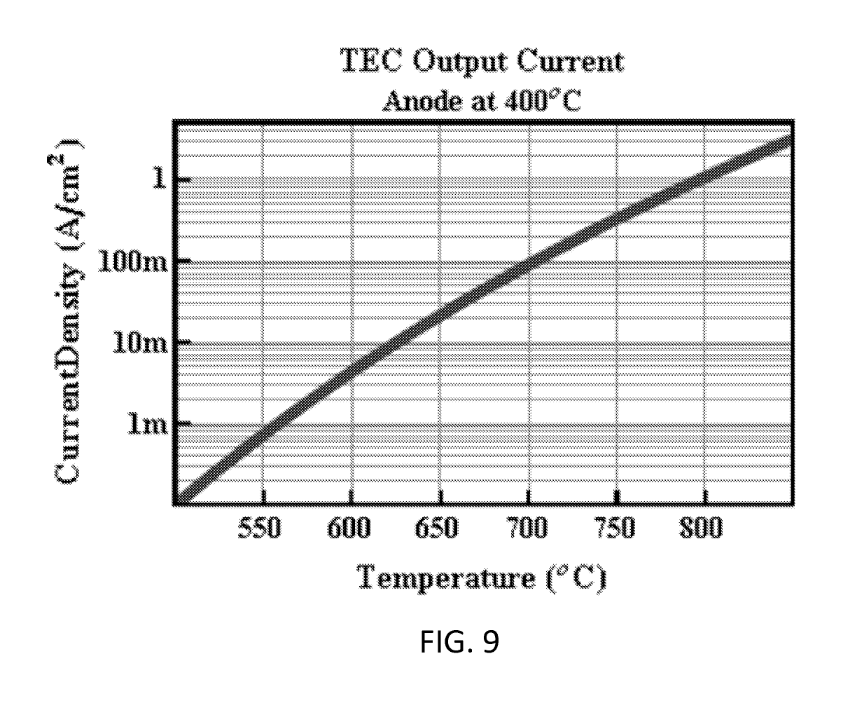

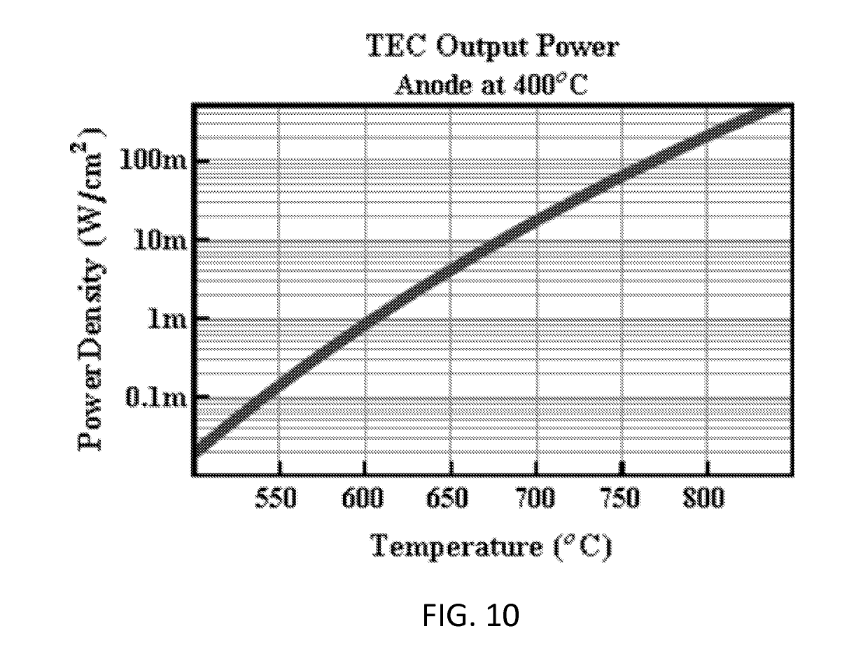

The potential output current and power of the all diamond ideal thermionic energy converter previously discussed have been calculated as a function of cathode temperature for an anode held constant at a reasonable temperature of 400° C., as shown in FIGS. 9 and 10. Assuming the effects of both the hydrogen plasma and the low pressure hydrogen environment are stable, this configuration could potentially achieve emission current densities of 1 A/cm² with an overall output power greater than 100 mW/cm² at a cathode operational temperature of only 800° C. This equates to the production of over 1 kW per square meter of electrical power from this technology. For comparison, a typical solar cell with a 20% efficiency would require 26,000 m² in order to achieve 1 MW of power output in the daylight [36]. Conversely, this preliminary analysis suggests a diamond based thermionic energy converter would require only 1000 m², which should only decrease with further work on this topic.

The results described above were all performed in a testing apparatus meant only to characterize the thermionic emission properties of diamond films (the most important material property for thermionic energy conversion devices). This testing apparatus required for an electric field (voltage) to be applied between the cathode and anode and could therefore not function as a TEC prototype. While the results were good indicators of actual energy conversion performance, it was not until the past year that a testing apparatus was created with the ability to act as a TEC prototype. This second testing apparatus utilized diamond films as both the cathode and anode electrodes. These electrodes were mounted parallel to each other in the two terminal configuration, as shown in FIG. 1 for example. Using cathode-anode spacings on the order of 100 μm and molecular hydrogen environments approaching 100 Torr, real power densities exceeding 100 μW/cm² have been obtained at temperatures below 1000° C. These output power densities have been consistently improved and are projected to exceed 1 mW/cm². While this progress is extremely promising, there remains numerous variables which must be optimized in order to reach this technology's full potential. The potential power output levels of several W/cm² at temperatures below 1000° C. which were extrapolated from past results are therefore still valid.

In addition, as disclosed above, a two terminal configuration is utilized the embodiments of the invention. It should be noted that a multi-terminal configuration can also be utilized to practice the invention.

### Potential Products/Applications

Efficient direct energy conversion systems could potentially revolutionize power generation systems for industrial/residential use, space exploration, and compact/portable applications, among many others. This same potential motivated the early research on thermoelectrics and thermionic converters, and the possibility of creating such systems that capitalize on the recent advances in material science inspires contemporary research on new thermionic emission devices. According to the invention diamond based thermionic energy conversion devices can be incorporated into larger systems that efficiently deliver high-capacity electrical energy for a variety of applications. This technology is extremely attractive as it can utilize virtually any thermal energy source such as coal, natural gas, biomass, fuel cells, radioisotopes, and solar radiation, among others.

A crucial facet of the technology is its ability to operate efficiently and robustly over broad temperature ranges. Though it is primarily desired to achieve high output power at temperatures well below 1000° C., the operational temperature of a diamond based TEC devices is only limited by the temperature at which it begins to graphitize, 1300° C. Further, thermionic emission energy conversion systems are mechanically simple, and consequently, could be highly cost effective. Conservative theoretical predictions of generation capacity indicate a potential capacity exceeding 1 W/cm², depending on temperature conditions. It can be predicted, based on similar chemical vapor deposition technologies, that nanodiamond cathode films could be produced at a cost of $1/cm² including depreciated capital and recurring fabrication expenses. Thus, the technology could be implemented at a cost of only $300/kW, including dc-ac power conversion hardware. This cost estimate compares very favorably to competitive technologies, including diesel generators (about $600/kW), gas turbines (about $500/kW), and fuel cells (greater than $1,000/kW). Further analysis shows that thermionic emission topping (or bottoming) cycles could be added to pulverized coal-fired boilers with a total system cost of $600/kW, which compares favorably to the $900/kW estimated for steam boiler systems.

The invention may address important needs in large-scale power generation. Current projections suggest that the world's demand for energy will increase dramatically in the coming decades. The majority of this increased demand will occur in developing countries, which presently have modest energy generation infrastructures. A new technology, such as that proposed here, that offers high efficiency and simple implementation would be appealing to these countries, which generally have modest non-energy resources. For power generation, a new device that operates with a thermal efficiency exceeding 60 percent, as compared to approximately 40 percent (which is common for modern steam power plants) would significantly reduce the amount of wasted energy.

The prospects for clean, renewable power generation could also be dramatically improved through the invention. Despite the many environmental benefits, energy generation from renewable sources will increase less rapidly than that from fossil fuels over the next twenty years. The primary impediments to the use of renewable energy are low conversion efficiency and high capital costs. The thermionic energy conversion technology described herein would be well suited for use as a highly efficient and potentially cost-effective solar-thermal energy converter. Other types of direct energy conversion devices, such as thermoelectrics or photovoltaics, do not currently possess the efficiency, capacity, or utility to make solar power generation competitive with fossil-fuel based systems.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

### LISTING OF REFERENCES

[1] N. S. Rasor, “Thermionic Energy Converter,” in Fundamentals Handbook of Electrical and Computer Engineering. vol. II, S. S. L. Chang, Ed., ed New York: John Wiley & Sons, Inc., 1983, pp. 668-679.
[2] J. M. Houston, Theoretical Efficiency of the Thermionic Energy Converter vol. 30: AIP, 1959.
[3] J. H. Ingold, “Calculation of the Maximum Efficiency of the Thermionic Converter,” Journal of Applied Physics, vol. 32, pp. 769-772, 1961.
[4] V. C. Wilson, “Conversion of Heat to Electricity by Thermionic Emission,” Journal of Applied Physics, vol. 30, pp. 475-481, 1959.
[5] N. S. Rasor, “Thermionic energy conversion plasmas,” Plasma Science, IEEE Transactions on, vol. 19, pp. 1191-1208, 1991.
[6] O. W. Richardson, “The Electrical Conductivity Imparted to a Vacuum by Hot Conductors,” Philosophical Transactions of the Royal Society of London. Series A, Containing Papers of a Mathematical or Physical Character, vol. 201, pp. 497-549, 1903.
[7] W. B. Nottingham, “Thermionic Emission,” Massachusetts Institute of Technology, Cambridge, Technical Report 321, Dec. 10 1956.
[8] F. J. Himpsel, J. A. Knapp, J. A. VanVechten, and D. E. Eastman, “Quantum photoyield of diamond(111)—A stable negative-affinity emitter,” Physical Review B, vol. 20, pp. 624-627, 1979.
[9] J. B. Cui, J. Ristein, M. Stammler, K. Janischowsky, G. Kleber, and L. Ley, “Hydrogen termination and electron emission from CVD diamond surfaces: a combined secondary electron emission, photoelectron emission microscopy, photoelectron yield, and field emission study,” Diamond and Related Materials, vol. 9, pp. 1143-1147, 2000.
[10] S. Albin and L. Watkins, “Current-voltage characteristics of thin film and bulk diamond treated in hydrogen plasma,” Electron Device Letters, IEEE, vol. 11, pp. 159-161, 1990.
[11] I. L. Krainsky, V. M. Asnin, G. T. Mearini, and J. A. Dayton, Jr., “Negative-electron-affinity effect on the surface of chemical-vapor-deposited diamond polycrystalline films,” Physical Review B, vol. 53, pp. R7650-R7653, 1996.
[12] W. F. Paxton, M. Howell, W. P. Kang, and J. L. Davidson, “Influence of hydrogen on the thermionic electron emission from nitrogen-incorporated polycrystalline diamond films,” Journal of Vacuum Science & Technology B: Microelectronics and Nanometer Structures, vol. 30, p. 021202, 2012.
[13] M. Kataoka, C. Zhu, F. A. M. Koeck, and R. J. Nemanich, “Thermionic electron emission from nitrogen-doped homoepitaxial diamond,” Diamond and Related Materials, vol. 19, pp. 110-113, 2010.
[14] M. Suzuki, T. Ono, N. Sakuma, and T. Sakai, “Low-temperature thermionic emission from nitrogen-doped nanocrystalline diamond films on n-type Si grown by MPCVD,” Diamond and Related Materials, vol. 18, pp. 1274-1277, 2009.
[15] W. F. Paxton, A. Steigerwald, M. Howell, N. Tolk, W. P. Kang, and J. L. Davidson, “The effect of hydrogen desorption kinetics on thermionic emission from polycrystalline chemical vapor deposited diamond,” Applied Physics Letters, vol. 101, p. 243509, 2012.
[16] N. S. Rasor, “Emission physics of the thermionic energy converter,” Proceedings of the IEEE, vol. 51, pp. 733-747, 1963.
[17] K. G. Hernqvist, “Analysis of the arc mode operation of the cesium vapor thermionic energy converter,” Proceedings of the IEEE, vol. 51, pp. 748-754, 1963.
[18] H. L. Witting and E. P. Gyftopoulos, “An Ionization Process in a Low-Energy Cesium Plasma,” Journal of Applied Physics, vol. 36, pp. 1328-1337, 1965.
[19] G. N. Hatsopoulos, “Transport effects in cesium thermionic converters,” Proceedings of the IEEE, vol. 51, pp. 725-733, 1963.
[20] I. Langmuir and K. H. Kingdon, “THERMIONIC EFFECTS CAUSED BY ALKALI VAPORS IN VACUUM TUBES,” Science, vol. 57, pp. 58-60, Jan. 12, 1923 1923.
[21] G. O. Fitzpatrick, E. J. Britt, and B. Moyzhes, “Updated perspective on the potential for thermionic conversion to meet 21st Century energy needs,” in Energy Conversion Engineering Conference, 1997. IECEC-97., Proceedings of the 32nd Intersociety, 1997, pp. 1045-1051 vol. 2.
[22] F. Maier, J. Ristein, and L. Ley, “Electron affinity of plasma-hydrogenated and chemically oxidized diamond (100) surfaces,” Physical Review B, vol. 64, p. 165411, 2001.
[23] F. A. M. Koeck, R. J. Nemanich, Y. Balasubramaniam, K. Haenen, and J. Sharp, “Enhanced thermionic energy conversion and thermionic emission from doped diamond films through methane exposure,” Diamond and Related Materials, vol. 20, pp. 1229-1233, 2011.
[24] O. Heber, R. Golser, H. Gnaser, D. Berkovits, Y. Toker, M. Eritt, M. L. Rappaport, and D. Zajfman, “Lifetimes of the negative molecular hydrogen ions: H₂⁻, D₂⁻, and HD⁻,” Physical Review A, vol. 73, p. 060501, 2006.
[25] B. M. Schwarzschild, “Negative ions of molecular hydrogen,” Physics Today, vol. 64, p. 23, 2011.
[26] H. Eyring, J. O. Hirschfelder, and H. S. Taylor, “The Theoretical Treatment of Chemical Reactions Produced by Ionization Processes Part I. The Ortho-Para Hydrogen Conversion by Alpha-Particles,” The Journal of Chemical Physics, vol. 4, pp. 479-491, 1936.
[27] B. L. Moiseiwitsch, “Electron Affinities of Atoms and Molecules,” in Advances in Atomic and Molecular Physics. vol. 1, D. R. Bates and I. Estermann, Eds., ed New York: Academic Press, 1965, pp. 61-83.
[28] I. Fischer-Hjalmars, “Theoretical Investigation of the Negative Hydrogen Molecule Ion,” The Journal of Chemical Physics, vol. 30, p. 1099, 1959.
[29] R. D. Harcourt, “A bound 2 Σg+ground state for H₂⁻? A valence-bond study,” Journal of Physics B: Atomic and Molecular Physics, vol. 20, p. L617, 1987.
[30] A. Dalgarno and M. R. C. McDowell, “Charge Transfer and the Mobility of H— Ions in Atomic Hydrogen,” Proceedings of the Physical Society. Section A, vol. 69, p. 615, 1956.
[31] B. Jordon-Thaden, H. Kreckel, R. Golser, D. Schwalm, M. H. Berg, H. Buhr, H. Gnaser, M. Grieser, O. Heber, M. Lange, O. Novotný, S. Novotny, H. B. Pedersen, A. Petrignani, R. Repnow, H. Rubinstein, D. Shafir, A. Wolf, and D. Zajfman, “Structure and Stability of the Negative Hydrogen Molecular Ion,” Physical Review Letters, vol. 107, p. 193003, 2011.
[32] V. I. Khvostenko and V. M. Dukel′skii, “Formation of negative H— ions in electron collisions with hydrogen molecules,” Zhurnal Eksperimental'noi i Teoreticheskoi Fiziki, vol. 33, p. 5, 1957.
[33] R. Golser, H. Gnaser, W. Kutschera, A. Priller, P. Steier, A. Wallner, M. \check{C}í\check{z}ek, J. Horá\check{c}ek, and W. Domcke, “Experimental and Theoretical Evidence for Long-Lived Molecular Hydrogen Anions H₂⁻ and D₂⁻,” Physical Review Letters, vol. 94, p. 223003, 2005.
[34] A. A. Shiryaev, D. Grambole, A. Rivera, and F. Herrmann, “On the interaction of molecular hydrogen with diamonds: An experimental study using nuclear probes and thermal desorption,” Diamond and Related Materials, vol. 16, pp. 1479-1485, 2007.
[35] M. S. Melnik, “Diamond Surfaces: Interactions with Hydrogen and Halogens,” Doctor of Philosophy PDF, Applied Physics, California Institute of Technology, Pasadena, Calif., 1997.
[36] R. Roberts, “Energy Sources and Conversion Techniques: What is our capability of meeting the energy needs of the future within the limitations of known energy resources and energy conversion technology,” American Scientist, vol. 61, pp. 66-75, 1973.

What is claimed is:

1. A thermionic energy converter, comprising:
an anode;
a cathode spaced from the anode to define a gap therebetween; and
molecular hydrogen incorporated into the gap.

2. The thermionic energy converter of claim 1, wherein at least one of the anode and the cathode is formed of diamond.

3. The thermionic energy converter of claim 2, wherein at least one of the anode and the cathode comprises a nitrogen-incorporated diamond film.

4. The thermionic energy converter of claim 1, wherein the molecular hydrogen incorporated into the gap is operably at a predetermined pressure.

5. The thermionic energy converter of claim 1, wherein the cathode is exposed to the molecular hydrogen such that H bonds and/or C—H bonds are formed on the surface of the cathode.

6. The thermionic energy converter of claim 1, wherein electrons emitted from the cathode and traversing towards the anode are of a function of temperature at the cathode.

7. An apparatus for thermal energy conversion, comprising at least one thermionic energy converter recited in claim 1.

8. A thermionic energy converter, comprising:
molecular hydrogen; and
a cathode of diamond exposed to the molecular hydrogen.

9. The thermionic energy converter of claim 8, further comprising an anode spaced from the cathode to define a gap therebetween.

10. The thermionic energy converter of claim 9, wherein at least one of the anode and the cathode comprises a nitrogen-incorporated diamond film.

11. The thermionic energy converter of claim 9, wherein the molecular hydrogen is incorporated into the gap, operably at a predetermined pressure.

12. The thermionic energy converter of claim 8, wherein H bonds and/or C—H bonds are formed on the surface of the diamond of the cathode.

13. The thermionic energy converter of claim 8, wherein electrons emitted from the cathode of diamond are of a function of temperature at the cathode.

14. An apparatus for thermal energy conversion, comprising at least one thermionic energy converter recited in claim 8.

15. A thermionic energy converter, comprising hydrogen.

16. The thermionic energy converter of claim 15, further comprising a cathode of diamond exposed to the hydrogen.

17. The thermionic energy converter of claim 16, further comprising an anode spaced from the cathode to define a gap therebetween.

18. The thermionic energy converter of claim 17, wherein the hydrogen is incorporated into the gap, operably at a predetermined pressure.

19. An apparatus for thermal energy conversion, comprising at least one thermionic energy converter recited in claim 15.

20. A thermionic energy converter, comprising:
a gaseous species; and
a cathode exposed to the gaseous species so as to form H bonds and/or C—H bonds on the surface of the cathode.

21. The thermionic energy converter of claim 20, wherein the gaseous species contains hydrogen.

22. The thermionic energy converter of claim 20, wherein the cathode is formed of diamond.

23. The thermionic energy converter of claim 20, further comprising an anode spaced from the cathode to define a gap therebetween.

24. The thermionic energy converter of claim 23, wherein the gaseous species is incorporated into the gap, operably at a predetermined pressure.

25. The thermionic energy converter of claim 20, wherein electrons emitted from the cathode are of a function of temperature at the cathode.

26. An apparatus for thermal energy conversion, comprising at least one thermionic energy converter recited in claim 20.

27. A thermal to electrical energy conversion device, comprising:
an anode;
a cathode for electron emission; and
hydrogen incorporated into a gap defined between the anode and the cathode.

28. The thermal to electrical energy conversion device of claim 27, wherein the cathode is exposed to the hydrogen.

29. The thermal to electrical energy conversion device of claim 27, wherein at least one of the anode and the cathode comprises a nitrogen-incorporated diamond film.

30. The thermal to electrical energy conversion device of claim 27, wherein the hydrogen incorporated into the gap is operably at a predetermined pressure.

31. The thermal to electrical energy conversion device of claim 27, wherein electrons emitted from the cathode and traversing towards the anode are of a function of temperature at the cathode.

32. An electron emission device, comprising:
a gaseous species; and
a cathode exposed to the gaseous species so as to form H bonds and/or C—H bonds on the surface of the cathode.

33. The electron emission device of claim 32, wherein the gaseous species contains hydrogen.

34. The electron emission device of claim 32, further comprising an anode spaced from the cathode to define a gap therebetween.

35. The electron emission device of claim 34, wherein at least one of the anode and the cathode is formed of diamond.

36. The electron emission device of claim 34, wherein the gaseous species is incorporated into the gap, operably at a predetermined pressure.

37. The electron emission device of claim 32, wherein electrons emitted from the cathode are of a function of temperature at the cathode.

38. A device operated by electron emission, comprising hydrogen.

39. The device of claim 38, further comprising a cathode of diamond exposed to the hydrogen.

40. The device of claim 39, further comprising an anode spaced from the cathode to define a gap therebetween.

41. The device of claim 40, wherein the hydrogen is incorporated into the gap, operably at a predetermined pressure.

42. A method for thermal energy conversion, comprising:
providing an anode and a cathode spaced from the anode to define a gap therebetween, wherein the cathode is formed of diamond;
incorporating hydrogen into the gap; and
heating the cathode at a desired temperature.

43. The method of claim 42, wherein the cathode comprises a nitrogen-incorporated diamond film.

44. The method of claim 42, wherein the hydrogen incorporated into the gap is operably at a predetermined pressure.

45. The method of claim 42, wherein electrons emitted from the cathode are of a function of the desired temperature.

46. A method for electron emission, comprising:
exposing a cathode to a gaseous species so as to form H bonds and/or C—H bonds on the surface of the cathode.

47. The method of claim 46, wherein the gaseous species contains hydrogen.

48. The method of claim 46, further comprising:
heating the cathode at a desired temperature.

49. The method of claim 48, wherein electrons emitted from the cathode are of a function of the desired temperature.
